(19) United States
(12) Patent Application Publication
(10) Pub. No.: US 2007/0113282 A1
(43) Pub. Date: May 17, 2007

(54) Systems and methods for detecting and disabling malicious script code

(76) Inventor: Robert F. Ross, Rancho Santa Margarita, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/281,839

(22) Filed: Nov. 17, 2005

(51) Int. Cl. G06F 12/14; G06F 11/00

(52) U.S. Cl. 726/22; 726/25

(57) ABSTRACT

In accordance with at least one embodiment of the present invention, a device for receiving and processing data content having at least one original function call includes a hook script generator and a script processing engine. The hook script generator is configured to generate a hook script having at least one hook function. Each hook function is configured to supersede a corresponding original function. The script processing engine is configured to receive and process a combination of the hook script and the data content. The hook function corresponding to the data content original function is executed when the original function is called. The hook function provides a run-time detection and control of the data content processing.

### TECHNICAL FIELD

The present invention relates generally to client and server network traffic, and more particularly, for example, to detecting and disabling malicious script code.

### RELATED ART

Many computer applications today utilize command scripts to perform a variety of tasks. A command script, or script code, typically is a computer file containing a sequence of text commands and arguments that conform to a particular scripting language convention or standard. An interpreter typically parses (i.e. reads) the script and executes (interprets) the script commands in a sequential manner so that commands at the beginning of a script are parsed and executed before later commands are parsed.

In contrast, compiled code is typically generated from one or more source code computer files containing a sequence of text commands and arguments that conform to a particular programming language, where the entire sequence of text and arguments are parsed before any commands are executed. Compiled programs require a separate compiling process where the source code is converted to a non-human readable machine code that may be directly executed on a targeted computer platform. Script languages typically take longer to interpret and execute than a compiled language program that is merely executed after compilation, but scripts can be very useful for shorter programs where the slower interpreter speed offsets the compile time overhead for the compiled code.

Java is the name of a general-purpose programming language that is well suited for use with clients and servers on the World Wide Web (WWW). Smaller Java programs or applications are called Java applets and can be downloaded from a web server and run on a local computer by a java-enabled web browser such as Microsoft's Internet Explorer (IE) or Netscape's Navigator. JavaScript is the name of a common scripting language that was developed originally by Netscape Communications and Sun Microsystems for use in Internet browser applications. JavaScript can be considered a client-side scripting language that is executed by an Internet browser, sometimes known as a web client because it connects to a web server to access web pages. In reference to FIG. 1, a traditional client-server system 100 is shown including a client network device 102 (client) and a server network device 104 (server) that can communicate with each other over a communications network 108 such as the Internet. Client 102 may be connected to Internet 108 through a switched-packet connection 110, while server 104 may be connected to Internet 108 through another switched-packet connection 112 where Client 102 and server 104 may exchange message packets comprising network data.

Client 102 may include a display 120 such as a video monitor, a keyboard 122, and a web browser 124. Server 104 may include a web server 160 configured to provide a plurality of web pages in a download mode to a requesting device such as client 102. Conversely, client 102 may also upload information onto web server 160. Web-browser 124 and web-server 160 may each be an application program running on a suitably programmed computer system. Web browser 124 may load a web page written in a Hypertext Markup Language (HTML) that contains a portion of embedded JavaScript code. The browser typically includes a built-in interpreter that reads and executes the JavaScript code. JavaScript may be used to automatically change formatted information on the requested web page, cause a linked page to appear in another browser window, and/or cause text and/or graphical images to change during a mouse rollover, for example.

The number of client side JavaScript attacks is increasing against Java-enabled web browsers such as Microsoft's Internet Explorer and/or Netscape's Navigator applications. Many problems have been found with improper classification of web content into security zones. Problems vary from cross-site scripting to the installation of new programs on the exploited host. This proliferation of JavaScript attacks results in pervasive problems spanning financial fraud to spyware installation. Some anti-spyware and anti-adware manufacturers attempted to introduce scripts to block browser pop-up ads, but this approach quickly became obsolete, as the sophistication of modern spyware/adware has increased.

Anti-virus and security companies have attempted to strike back, but the usual response is to create signatures for known pieces of malicious program code including JavaScript. A signature is like a fingerprint of a particular portion of a program or portion of code that uniquely identifies this code. To avoid detection, some attackers obfuscate their scripts so that the signatures do not match the resulting code. Another method of obfuscation includes string concatenation of the string fragments “ADO”, “DB.”, and “Stream” that may be concatenated into the string “ADODB.Stream”. Alternatively, some attackers have used a Microsoft Script Encoder (screnc.exe) tool to pass the entire script through a text-encoding cipher that replaces the original text of the script file. In this manner, script encoding requires a script viewer to go through a specific decoding process to retrieve the original script code.

Script-based code execution has many security vulnerabilities and traditional approaches to resolve these security problems have not been sufficiently effective. Signature based detection is one of the strongest tools available other than simply setting a kill bit in the registry, but it is far too simple to circumvent signature based checks. While decoders have emerged to reverse the actions of screnc.exe, string concatenation and other simple programmatic obfuscation techniques have an infinite number of variations with which signatures cannot always keep up. In view of these issues and others, there remains a need in the art for methods and systems that reliably detect malicious script code without relying on string and/or signature detection.

### SUMMARY

Systems and methods are disclosed herein, in accordance with one or more embodiments of the present invention related to validating script code, such as JavaScript, in a way that checks the final result of the code and doesn't simply look for strings within the code block. A hook-based detection engine, for example running as JavaScript, may catch the actual method calls regardless of the formatting of the code text, thus providing a far greater ability to detect script-based attacks than traditional security systems and methods.

More specifically, in accordance with an embodiment of the present invention, a device for receiving and processing data content having at least one original function call includes a hook script generator and a script processing engine. The hook script generator is configured to generate a hook script having at least one hook function. Each hook function is configured to supersede a corresponding original function. The script processing engine is configured to receive and process a combination of the hook script and the data content. The hook function corresponding to the data content original function is executed when the original function is called. The hook function provides a run-time detection and control of the data content processing.

In accordance with another embodiment of the present invention, a web client device includes a transceiver, a detection engine, and a script processing engine. The transceiver is configured to receive a data content from a network. The data content includes at least one original function call. The detection engine includes a hook script generator configured to generate a hook script including at least one hook function. Each hook function is configured to supersede a corresponding original function. The script processing engine is configured to receive and process the hook script and the data content. The hook function corresponding to the data content original function is executed when the original function is called. The hook function provides a run-time detection and control of the data content processing.

In accordance with yet another embodiment of the present invention, a method of processing data content comprising the operations of generating a hook script having at least one hook function where each hook function is configured to supersede a corresponding original function, loading the hook script into a script processing engine configured to call and execute one or more hook and original functions, loading data content having at least one original function into the script processing engine, and executing a hook function when a corresponding original function is called in the data content.

A computer readable medium on which is stored a computer program for executing instructions, comprising the operations of generating a hook script having at least one hook function where each hook function is configured to supersede a corresponding original function, loading the hook script into a script processing engine configured to call and execute one or more hook and original functions, loading data content having at least one original function into the script processing engine, and executing a hook function when a corresponding original function is called in the data content.

The scope of the present invention is defined by the claims, which are incorporated into this section by reference. A more complete understanding of embodiments of the present invention will be afforded to those skilled in the art, as well as a realization of additional advantages thereof, by a consideration of the following detailed description. Reference will be made to the appended sheets of drawings that will first be described briefly.

### BRIEF DESCRIPTION OF THE DRAWINGS

FIG. 1 shows a traditional client-server system including a client network device and a server network device that can communicate with each other over a communications network such as the Internet.

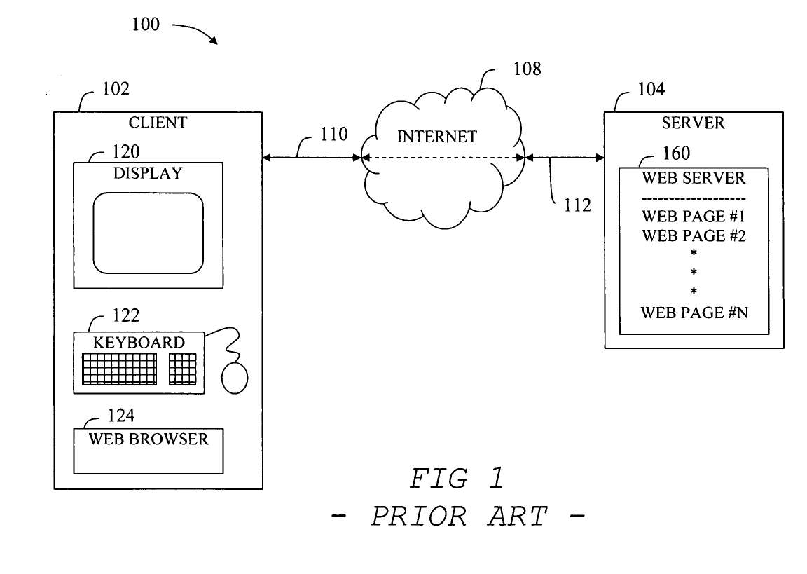

FIG. 2 shows an exemplary client-server system including a client network device (client) and a server network device (server) according to an embodiment of the present invention.

FIG. 3 shows an example of original script code received as HTTP content, for example, downloading a web page from a web server.

FIG. 4 shows a combined script including a generated hook script and the original script code shown in FIG. 3, according to an embodiment of the present invention.

FIG. 5 shows a script validation flow according to an embodiment of the present invention.

FIG. 6 shows a data flow block diagram illustrating both a structure and a process for detecting and selectively disabling potentially malicious script code according to an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

Systems and methods are disclosed herein, in accordance with one or more embodiments of the present invention, to detect and disable potentially malicious script code by the activation of a detection engine that can detect and control the behavior of suspected malicious script code to limit adverse program behaviors while promoting desirable program behaviors.

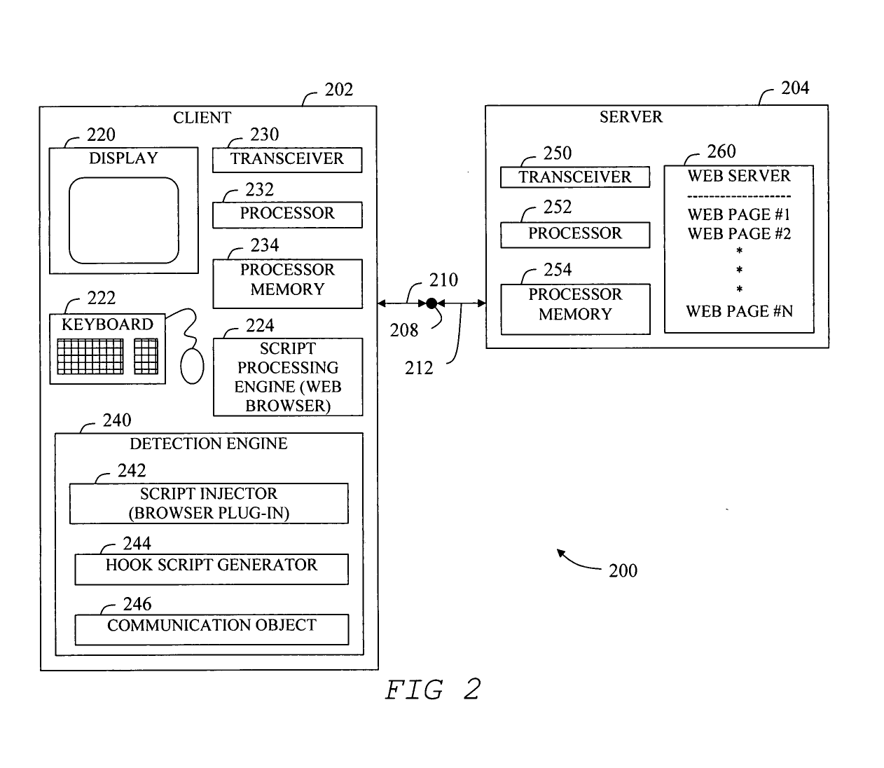

FIG. 2 shows an exemplary client-server system 200 including a client network device 202 (client) and a server network device 204 (server) according to an embodiment of the present invention. Client 202 and server 204 can communicate with each other over a communications network 208 such as the Internet to exchange information including web content comprising text, image, audio, and/or video data. Client 202, may be considered a web client 202, and may include a display 220 for displaying graphical images and/or producing sound to a user constituting a user output device, a data entry device 222 for receiving data input from a user constituting a user input device, and/or a script processing engine 224, such as a web browser 224, for receiving the web content and translating the web content into one or more client actions. A client action may convey output data to a user include displaying or outputting the text data, image data, video data, interactive control data, and/or the audio data. In this manner, web browser 224 provides a graphical user interface (GUI) to locate and display web pages in order to interactively access text, program, image, as well as sound data available through the World Wide Web (WWW). The terms script processing engine 224 and web browser 224 may be used somewhat interchangeably since a web browser typically includes a script processing engine. Data entry device 222 may include a keyboard for text entry and/or a pointing device for point-and-click information entry by a user. Alternatively, data entry device 222 may be any combination of sensors to detect data entry by a user. Display 220 and keyboard/pointing device 222 comprise a user interface (UI).

Client 202 may include a transceiver 230 for sending and receiving messages on network 210, a processor 232 for executing computations and operations to move and/or transform data within client 202 and control client operations, and a processor memory 234 for storing and retrieving data relevant to client operations. Transceiver 230 may include a device such as a network interface card (NIC) and/or related software for providing communications between client 202 and network 210. Processor 232 may include one or more suitably programmed microprocessors, while processor memory 234 may be any data storage and retrieval system including any combination of a Random Access Memory (RAM), a Read Only Memory (ROM), a register file, a disc drive including magnetic media, and/or an optical memory device as a computer readable medium on which is stored a computer program for executing instructions. Some portion of processor memory 234 may be removable from client 202. Web browser 224 may be implemented as an application program or collection of programs running at least partially on a computer such as processor 232.

To detect potentially malicious script code, client 202 includes a hook-based detection engine 240 that is configured to catch actual script method calls regardless of the formatting of the code text. Detection engine 240 may be implemented by a script, such as a JavaScript, executing on a computer such as processor 232. The JavaScript language uses late binding which refers to the linking or calling of a process, routine, or object at runtime based on current conditions. Since JavaScript uses late binding, it is possible to replace or modify arguments and functions, thus effectively replacing objects by changing their class constructor function. For the purposes of this disclosure, a constructor is a function that is used to instantiate a new object and returns the newly created instance of that object.

In one embodiment, detection engine 240 includes a script injector 242, a hook script generator 244, and/or a communication object 246. Script injector 242 may intercept incoming data content, such as HTTP data, and introduce the incoming data to script processing engine 224. Incoming data may be, for example, a requested web page delivered over network 208. Script injector 242 may be implemented as a browser plug-in, such as a Multipurpose Internet Mail Extensions (MIME) plug-in, for web browser 224. Hook script generator 244 creates new functions, including constructor functions, which replace the standard JavaScript functions. Alternatively, hook script generator 244 may create a generic hook script off-line for archive or reading in to a remote client through a network 208 or other delivery means. In this manner, a script manufacturer may design and distribute a hook script for use by a plurality of client end-users. The distributed hook script may be read in to a web browser prior to reading in any web page in order to provide run-time detection and control of the data content processing for the remote client. In another embodiment, some portion or all of detection engine 240 may be physically located away from client 202. Some portion or all of detection engine 240 may be moved onto another platform termed a third device, and may be implemented as another client device (not shown), an auxiliary device operationally connected to client 202 (not shown), and/or a network device that intercepts messages up to an including all traffic between connection networks 208 and 210. In one example, the script injection and generation could be accomplished by the third device.

Communication object 246 is configured to provide a run-time exchange of messages (data) between various processes or threads for programs running on processor 232. In this manner, the output of a particular hooked function and/or routine may be directed towards a particular message receiver, such as another process or a device within client 202 or connected to client 202 via network 210. In one example, communication object 246 can relay data between the script code executing on script processing engine 224 and another process or service including a virus scanning or a security management service.

One example of this type of security management service is a network security application Blink® produced by eEye Digital Security of Aliso Viejo, Calif. Blink® provides an endpoint vulnerability solution that addresses security challenges by preventing a successful attack. The Blink service typically runs in parallel with detection engine 240 and uses one or more communication objects 246 to relay data back and forth between detection engine 240 and the Blink service.

Script injector 242 can be a Multipurpose Internet Mail Extensions (MIME) filter plug-in for use with a traditional browser such as Microsoft's Internet Explorer (IE) and/or Netscape's Netscape Navigator. Script injector 242 may also be considered a “pluggable” MIME filter since it may be implemented as a browser plug-in or extension. MIME capability permits the formatting of non-ASCII (American Standard Code for Information Interchange) messages so that they can be sent over a communications link such as the Internet 208. Many e-mail clients and browsers support various MIME types that allow them to send and receive graphics, audio files, video files, and use character sets other than standard ASCII. Further, MIME enabled browsers can typically display or output files that are not in HTML format. MIME is continually evolving as a standard and includes various types with many differences. For reference, an early MIME protocol is defined by an Internet Engineering Task Force (IETF) request for comments (RFC) No. 2045 “Multipurpose Internet Mail Extensions”, also denoted IETF-RFC2045. A new version called S/MIME supports encrypted messages and is referenced in IETF-RFC2633 “S/MIME Version 3 Message Specification”. Script injector 242 is configured to inject the JavaScript that hooks the critical functions and methods before any other HTML in a loading page. In this manner, the script filter injects the JavaScript created by script generator 244. For the purposes of this disclosure, a method is associated with a class in an object-oriented programming environment and is analogous to a procedure, function, or routine that is executed when a method object receives a message. Further, a method argument is an input to a method. A constructor defines actions that are performed when an object is created. A class definition can contain zero or more constructors.

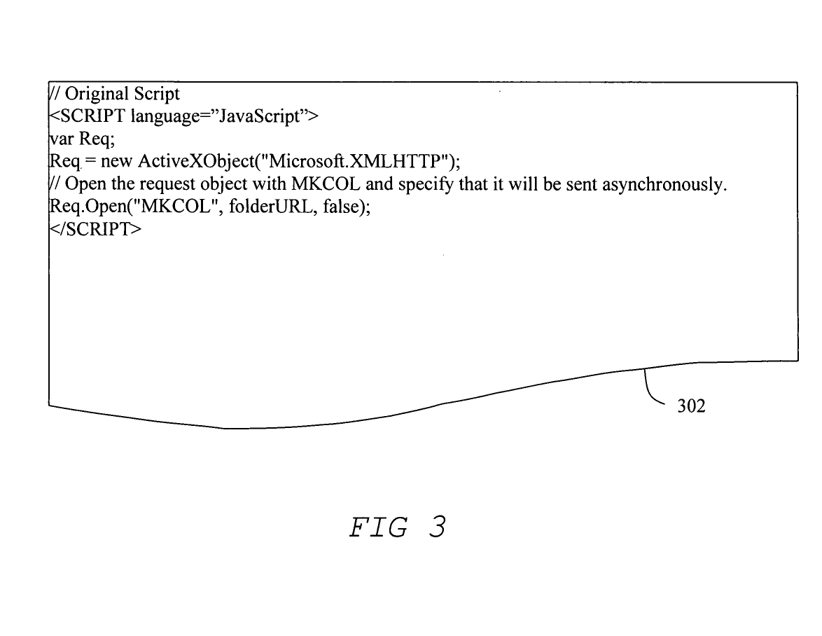

FIG. 3 shows an example of original script code 302 received as data (HTTP) content, for example, downloading a web page from a web server. In one example, an original constructor can be an ActiveXObject ( ) function that enables and returns a reference to an automation object. In this example, there are two exemplary actions that the Microsoft.XMLHTTP ActiveXObject can perform; method calls defined as Open and SaveToFile. A client computer can use a Microsoft.XMLHTTP object to send an arbitrary HTTP request, receive the response, and/or have the Microsoft extensible markup language (XML) document object model (DOM) parse that response.

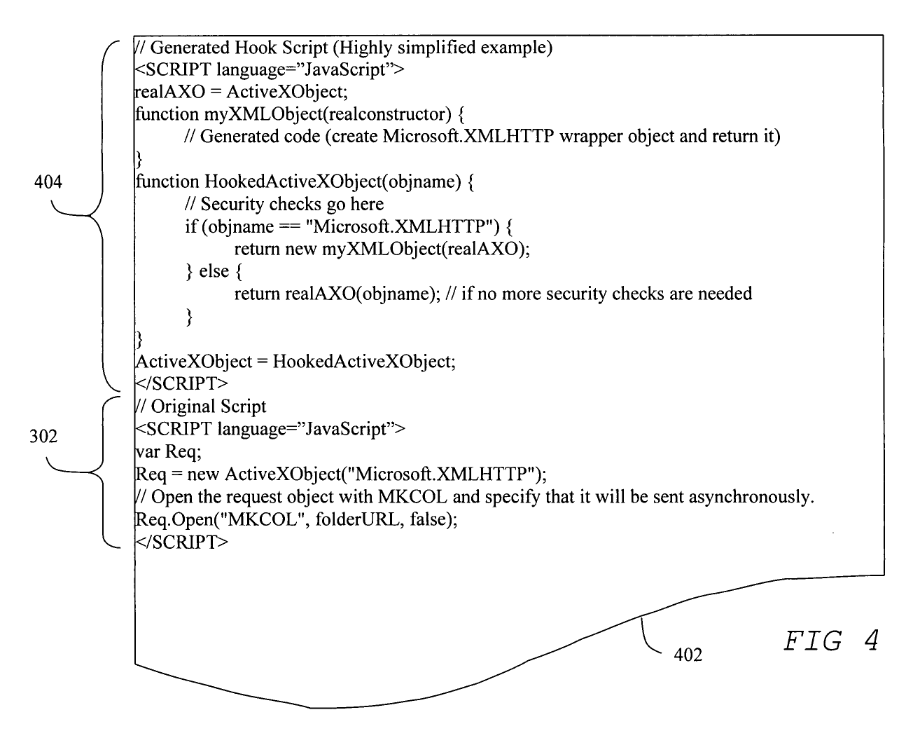

FIG. 4 shows an example of a combined script 402 including a generated hook script 404 and original script code 302 shown in FIG. 3, according to an embodiment of the present invention. Although shown as a single, combined script 402, generated hook script 404 and original script code 302 may be introduced, or injected, into script processing engine 618 individually by any means as long as a hook script function corresponding to an original script function is processed first. The combination of hook script 404 and original script 302 into combined script 402 is not intended as a limitation. In this example, since the requested automation object in the script is “Microsoft.XMLHTTP”, then instead of returning an automation object directly a new object can be created as a wrapper for the automation object. All properties and methods of the XMLHTTP object are present in the new wrapper object, and any method calls may be passed on to the original automation object. In this manner, validity checks can be performed to validate method arguments before allowing the function call. With XMLHTTP, the wrapper could filter out downloads referenced by a file path that includes a uniform resource locator (URL) on an untrusted hosts. Also, a wrapper object around ADODB.Stream could allow validation of the file path before allowing a SaveToFile or other method to execute. This could prevent files from being written into the Windows system directory, for example, while still allowing use of the object for other purposes.

Code generation will be used to simplify the process of creating new wrappers for one or more ActiveXObjects. The input to the code generator consists of a description of the object to be wrapped. Some portions of this input include the name of the automation object, the properties of the object, and the methods of the object. Since properties cannot be hooked, they may be loaded and/or set before and/or after calls to various methods. Each method shall be marked with whether it should set properties before the real method call or load them after a method call completes. Some more exotic methods may have custom code provided for them instead of a simple description of how to proxy a specific method call or class. These custom methods will be the key check points for the detection engine. Examples include the SaveToFile method of ADODB.Stream and the Open method of Microsoft.XMLHTTP.

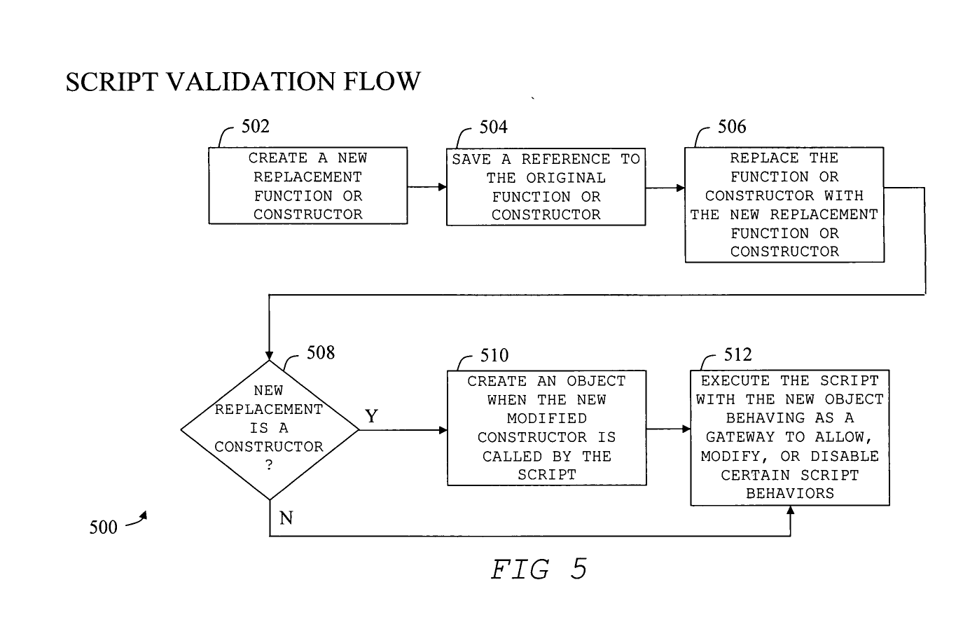

FIG. 5 shows an exemplary script validation flow 500 according to an embodiment of the present invention. Flow 500 shows a process of hooking one or more functions in the received content and selectively disabling potentially malicious methods or function by validating the method or function arguments and/or run-time conditions before allowing the execution of a potentially malicious function call. Flow 500 includes the operations of creating 502 a new replacement function or constructor, saving 504 a reference to the original function or constructor, and replacing 506 the original function or constructor with a new replacement function or constructor that acts as a wrapper for the original function or constructor. Flow 500 continues in operation 508 depending on whether the new replacement (hook) function is a constructor. If the new replacement function is a constructor, flow 500 continues with creating 510 a new wrapper object when called, and executing 512 the modified script with the new object behaving as a gateway to allow, modify, or disable certain script behaviors. Operation 512 may occur without operation 510 in cases where the hooked function is a simple non-constructor function. These allowed or inhibited behaviors can include particular script commands, script command argument combinations, and/or method, argument, and property combinations.

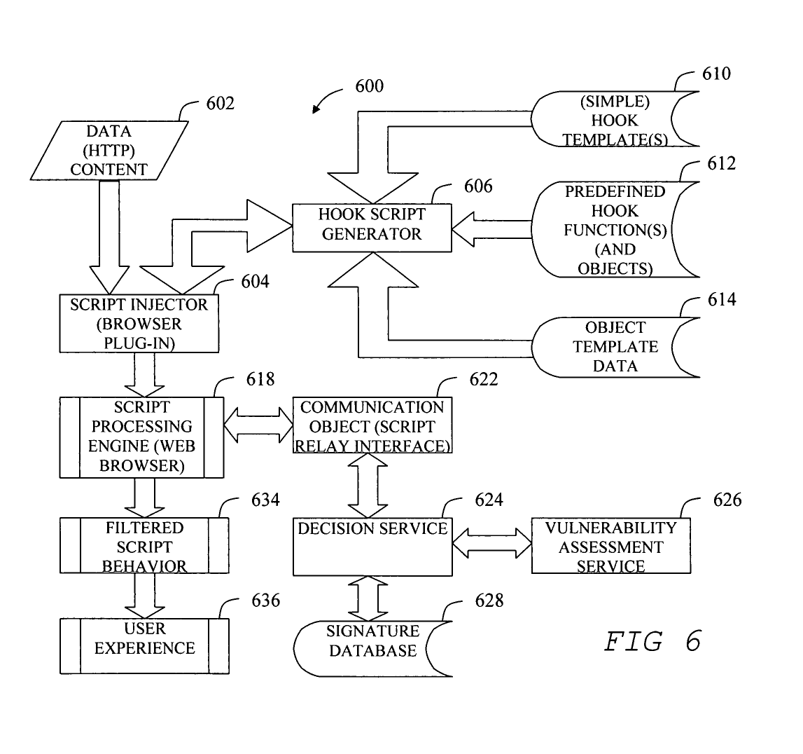

FIG. 6 shows an exemplary data flow block diagram 600 illustrating both a structure and a process for detecting and selectively disabling potentially malicious script code according to an embodiment of the present invention. As a structure, data (HTTP) content 602, such as downloaded from a web page, is received by a script injector/filter (browser plug-in) 604 which is an exemplary embodiment of script filter 242 (FIG. 2). Data content 602 may include a script program with one or more original functions for execution on the receiving client. A hook script generator 606 may receive some portion or all of data content 602 and supply a generated script code including one or more hook functions configured to replace corresponding original functions. Hook script generator 606 is an exemplary embodiment of script generator 244 (FIG. 2). This process of substituting an original function or method with a filtered function can be denoted instantiating a “hooked” processes. Alternatively, data content 602 that does not include a script and/or an original function corresponding to a hook function would simply be received and processed without modification.

Hook script generator 606 may receive input from one or more simple hook templates 610, one or more predetermined hook functions and objects 612, and/or object template data 614. Using one or more of these as input, hook script generator 606 produces a hook script, such as a JavaScript output that may consist of hook functions, new objects that will be used as replacements when the appropriate constructor is invoked, and/or new constructors that will return the hooked objects in place of the standard objects. These hooks are installed before any other script on the web page loads, ensuring that any script provided as a part of the data content 602, such as a web page, will call the new hooked functions. The generated (hooked) script code supplied to script filter 604 may be passed to a script processing engine 618 may be implemented as a stand-alone computer program running as an executed script. Alternatively, script processing engine 618 may be included as an operational portion of a web browser, which may be implemented as an application program running on a computer such as processor 232 (FIG. 2). Script processing engine 618 may communicate to a script relay interface 622 by passing messages through a communications object which is an exemplary embodiment of communications object 246 (FIG. 2).

The information passed to the decision service may include the method name, the object name, any parameters passed to the method, as well as relevant object properties or global variable values. In one embodiment, the decision service is the Blink service. Script relay interface 622 passes messages between web browser 618 and a decision service 624 that can be a security service such as Blink, produced by eEye Digital Security. A relay interface is necessary to provide a means for JavaScript running in an untrusted domain to communicate with the decision service using normal mechanisms of Inter-Process Communication (IPC). Decision service 624 can receive messages describing the run-time behavior of JavaScript that has been loaded in web browser 618 and determine whether the suspected malicious code behavior should be allowed or prohibited as well as provide event logging by recording when one or more different types of behavior analysis events occur. To make this determination, decision service 624 may exchange data with a vulnerability assessment service 626 that performs detailed analysis of suspected malicious code functions and one or more arguments to gauge whether these arguments and functions in combination or separately may constitute an undesirable code behavior and/or a security threat. Vulnerability assessment unit 626 may determine whether the received content poses a threat based on real-time identification of threats including a protocol based intrusion, spyware exposure, and/or exposure of a user to identity theft.

Decision service 624 may exchange messages with a signature database 628 to further classify and/or identify a suspected malicious code script and/or script portion. Signature database 628 can provide script signature data in response to a script query from decision service 624. Once decision service 624 has made a determination regarding a particular script, that decision information may be passed through script relay interface 622 to web browser 618 in order to produce a filtered script behavior 634 such as disabling the execution of an original function if it is determined to be malicious, or allowing the execution of the original function if it is not determined to be malicious. The filtered script may be executed on processor 232 and/or another processor to produce a user experience 636 in the form of data output to a user and/or data received from the user. In this manner, received data (typically HTTP) content 602 may be filtered to prevent execution of potentially malicious script behaviors prior to execution where the hook function provides a run-time detection and control of the data content processing.

As a process, the flow 600 of FIG. 6 shows a method of processing data content 602 comprising the operations of generating a hook script having at least one hook function where each hook function is configured to supersede a corresponding original function, loading the hook script into a script processing engine configured to call and execute one or more hook and original functions, loading data content 602 having at least one original function into the script processing engine, and executing a hook function when a corresponding original function is called in data content 602. Flow 600 may continue with the operations of modifying or disabling the execution of the original function if it is determined to be malicious, and allowing the execution of the original function if it is determined not to be malicious. The execution of the original function may be modified if such modification is permissible and/or desirable. For example, the original function may include writing an output into a first directory that is undesirable for practical or security reasons. If so, the hook function may instead cause the output to be redirected to a second directory that is desirable. In this manner, some portion of the original function may be preserved, while another portion may be modified. In this example, the writing of data to a directory is accomplished, but the target directory was changed to improve security and/or avoid a security issue, for example. Alternatively, the executed hook function may pass a message to decision service 624 that is used in a vulnerability assessment, the outcome of which may provoke a change in the script execution (modify, disable, allow) due to one or more run-time conditions. Some portion or all of flow 600 may be embodied as a computer readable medium on which is stored a computer program for executing instructions.

As with any security system or method, potential concerns may arise regarding the possibility that malicious JavaScript may attempt to circumvent the above detecting and disabling processes including identifying the variable that stores the original ActiveXObject constructor, identifying the property of our wrapper object that references the real internal ActiveXObject, and/or identifying functions used by the wrapper and replacing them. To safeguard against this, the script generator 606 may create a randomized variable name to store the original ActiveXObject constructor so malicious code cannot simply use it instead. The property that holds a reference to the ActiveXObject instance internal to the wrapper object may also be randomized when the code is generated. Finally, to prevent replacing the functions used by the wrapper object they may be created as unnamed functions existing only in the wrapper object's reference to them.

Configuration for hook script generator 606 may depend on one or more rules in one or more EXtensible Markup Language (XML) files. In the case of Blink, parameters for the hook script generator 606, such as object name and method descriptions, may be stored as a string in Blink's ExtraData field for a rule. Every object that is wrapped may have a one-to-one mapping with a rule containing this description. All protocol entity checks such as signature checks on the path to which a file will be saved can be handled by an ActiveX automation object 622 that communicates back to the security service through the same LPC interface used by the script filter (browser plug-in) 604.

Decision service 624 may be incorporated within a security service that is either resident with a particular client or accessible remotely via the network connection. Decision service 624 may provide event logging and threat level determinations to allow or deny a script method call. An automation object instantiated in the script code provides a communications channel for passing messages to the security service. The communications (COM) object underlying the ActiveXObject for communicating with a security service may then use the existing Local Procedure Call (LPC) interface employed by the web browser. This chain will provide a mechanism for querying the service regarding the safety of method parameters as well as a mechanism for logging from the wrapper object. A replacement constructor for an ActiveXObject will be created to inhibit creation of security service interface objects and ensure only the script generator 606 of the detection engine will be aware of any mechanism to access the original constructor, and thus will be able to communicate with the security service.

Embodiments described above illustrate but do not limit the invention. It should also be understood that numerous modifications and variations are possible in accordance with the principles of the present invention. Accordingly, the scope of the invention is defined only by the following claims.

I claim:

1. A device for receiving and processing data content having at least one original function call, the device comprising:
a hook script generator configured to generate a hook script having at least one hook function, each hook function being configured to supersede a corresponding original function; and
a script processing engine configured to receive and process a combination of the hook script and the data content, the hook function corresponding to the data content original function being executed when the original function is called, the hook function providing run-time detection and control of the data content processing.

2. The device of claim 1, wherein the hook function calls the original function.

3. The device of claim 1, the hook script generator further comprising at least one of:
a hook template;
a predefined hook function; and
an object template.

4. The device of claim 1, wherein the hook script generator creates a randomized variable configured to store an original constructor.

5. The client device of claim 1, wherein a property that holds a reference to the superseded function is randomized when the hook script code is generated.

6. The device of claim 1, wherein the data content format conforms to the hypertext transfer protocol (HTTP).

7. The client device of claim 6, wherein the data content includes a web page.

8. The device of claim 1, wherein the script processing engine is included in a web browser.

9. The device of claim 1, further comprising:
a script injector configured to receive the hook script and the data content and produce a unified output, the unified output being arranged so that the script processing engine processes a hook function before processing a corresponding data content original function.

10. The device of claim 9, wherein the script injector is a web browser multipurpose internet mail extensions (MIME) filter.

11. The device of claim 1, wherein at least one hook function provides a security check capability to one of validate and invalidate at least one original function execution capability.

12. The device of claim 11, further comprising:
a decision service configured to receive information from the run-time execution environment and hooked function and one of validate and invalidate at least one of the hooked function and the hooked function arguments; and
a communication object configured to at least one of send and receive message information between the script processing engine and the decision service to one of validate and invalidate at least one of the hooked function and the hooked function arguments.

13. The device of claim 12, wherein the communication object is a script relay interface.

14. The system of claim 12, further comprising a signature database configured to provide signature analysis of any portion of the data content.

15. The system of claim 12, further comprising a vulnerability assessment service configured to determine whether at least one of the function and one or more arguments constitute one of an undesirable code behavior and a security threat.

16. A web client device, comprising:
a transceiver configured to receive a data content from a network, the data content including at least one original function call;
a detection engine including a hook script generator, the hook script generator being configured to generate a hook script including at least one hook function, each hook function being configured to supersede a corresponding original function; and
a script processing engine configured to receive and process the hook script and the data content, the hook function corresponding to the data content original function being executed when the original function is called, the hook function providing run-time detection and control of the data content processing.

17. The web client device of claim 16, the script processing engine being a part of a web browser, the web client further comprising:
a user input device configured to receive data input from a user and provide a user input to the web browser; and
a user output device configured to convey output data from the web browser to a user.

18. A method of processing data content, the method comprising the operations of:
generating a hook script having at least one hook function, each hook function being configured to supersede a corresponding original function;
loading the hook script into a script processing engine configured to call and execute one or more hook and original functions;
loading data content having at least one original function into the script processing engine; and
executing a hook function when a corresponding original function is called in the data content.

19. The method of claim 18, further comprising:
determining whether the original function is malicious; and one of:
modifying the execution of the original function if it is determined to be malicious and a modification is permissible;
disabling the execution of the original function if it is determined to be malicious; and
allowing the execution of the original function if it is determined not to be malicious.

20. A computer readable medium on which is stored a computer program for executing instructions, comprising the operations of:
generating a hook script having at least one hook function, each hook function being configured to supersede a corresponding original function;
loading the hook script into a script processing engine configured to call and execute one or more hook and original functions;
loading data content having at least one original function into the script processing engine; and
executing a hook function when a corresponding original function is called in the data content.
